(19) United States
(12) Patent Application Publication
(10) Pub. No.: US 2022/0107996 A1
(43) Pub. Date: Apr. 7, 2022

(54) INFORMATION PROCESSING APPARATUS AND INFORMATION PROCESSING SYSTEM

(71) Applicant: FUJIFILM Business Innovation Corp., Tokyo (JP)

(72) Inventor: Kei OTSU, Kanagawa (JP)

(73) Assignee: FUJIFILM Business Innovation Corp., Tokyo (JP)

(21) Appl. No.: 17/318,224

(22) Filed: May 12, 2021

(30) Foreign Application Priority Data
Oct. 1, 2020 (JP) 2020-166860

(51) Int. Cl. G06F 21/12; G06F 21/31; G06F 21/60

(52) U.S. Cl. CPC G06F 21/121; G06F 2221/0757; G06F 21/604; G06F 21/31

(57) ABSTRACT

An information processing apparatus includes a storage device that stores, for each user, information about a user-authentication apparatus corresponding to the user; and a processor configured to: in response to a first user asking for token information for product activation, request a first user-authentication apparatus to authenticate the first user, the first user-authentication apparatus being identified to correspond to the first user by the information stored in the storage device; in response to reception of information indicating successful authentication of the first user from the first user-authentication apparatus as a response to the request, issue the token information to the first user; and, in response to reception of token information input from the first user, control whether to issue license information to the first user based on a determination whether the token information input from the first user matches the token information that has been issued to the first user.

### CROSS-REFERENCE TO RELATED APPLICATIONS

This application is based on and claims priority under 35 USC 119 from Japanese Patent Application No. 2020-166860 filed Oct. 1, 2020.

### BACKGROUND

### (i) Technical Field

The present disclosure relates to an information processing apparatus and an information processing system.

### (ii) Related Art

A system that authenticates licenses of software or another target, which is used through licensing, first authenticates a user who requests a license. When the user authentication succeeds, the system determines whether a license is allowed to be granted to the user. When the system determines that a license is allowed to be granted, the system issues license information to the user. In this type of system in the related art, the system itself or a specific user authentication system prepared for the system performs user authentication. Therefore, a user, who wants to receive license information, needs to register their own authentication information (for example, a password or biometric information such as their fingerprint) with the system or the specific user authentication system prepared for the system.

In contrast, companies preparing identity providers (IdPs), for example, to manage their employees' use of cloud services as in Azure Active Directory™ have become popular. Authentication of a user by an IdP allows the user to perform single sign-on to services federated with the IdP.

The system disclosed in Japanese Unexamined Patent Application Publication No. 2003-84852 obtains a user's software purchase information in advance. When the user installs the software, the system associates product identification information (for example, the serial number or the product number) of the software with the purchase information. The system manages user information, which is input in activation of the installed software, automatically-obtained terminal identification information of a user terminal, the product identification information, and the software purchase information in association with one another. The system uses a license management server to manage these types of information in association with the state of issue of licenses. Upon reception, from a user terminal, of a request to start use of the software, the license management server refers to the state of issue of licenses, and issues a license on the basis of the preset purchase information.

### SUMMARY

Aspects of non-limiting embodiments of the present disclosure relate to an information processing apparatus which enables issue of license information to a user on the basis of the result of user authentication performed by an existing user-authentication apparatus used by the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a storage device and a processor. The storage device stores, for each user, information about a user-authentication apparatus corresponding to the user. The processor configured to, in response to a first user asking for token information for product activation, request a first user-authentication apparatus to authenticate the first user. The first user-authentication apparatus is identified to correspond to the first user by the information stored in the storage device. The processor configured to, in response to reception of information indicating successful authentication of the first user from the first user-authentication apparatus as a response to the request, issue the token information to the first user. The processor configured to, in response to reception of token information input from the first user, control whether to issue license information to the first user based on a determination whether the token information input from the first user matches the token information that has been issued to the first user.

### BRIEF DESCRIPTION OF THE DRAWINGS

Exemplary embodiment of the present disclosure will be described in detail based on the following figures, wherein:

FIG. 1 is a diagram illustrating an exemplary system configuration according to an exemplary embodiment;

FIG. 2 is a diagram illustrating exemplary authentication-type information managed by a portal server;

FIG. 3 is a diagram illustrating exemplary license management information managed by a product activation server;

FIG. 4 is a diagram illustrating the flow of a user registration process;

FIG. 5 is a diagram illustrating exemplary screen transitions in a product activation process on target software included in an online client personal computer (PC);

FIG. 6 is a diagram illustrating a part of an exemplary flow of a product activation process on target software included in an online client PC;

FIG. 7 is a diagram illustrating a part of an exemplary flow of a product activation process on target software included in an online client PC;

FIG. 8 is a diagram illustrating a part of an exemplary flow of a product activation process on target software included in an online client PC;

FIG. 9 is a diagram illustrating a part of an exemplary flow of a product activation process on target software included in an online client PC;

FIG. 10 is a diagram illustrating exemplary screen transitions in a product activation process on target software included in an offline client PC;

FIG. 11 is a diagram illustrating a part of an exemplary flow of a product activation process on target software included in an offline client PC;

FIG. 12 is a diagram illustrating a part of an exemplary flow of a product activation process on target software included in an offline client PC;

FIG. 13 is a diagram illustrating a part of an exemplary flow of a product activation process on target software included in an offline client PC;

FIG. 14 is a diagram illustrating a part of an exemplary flow of a product activation process on target software included in an offline client PC;

FIG. 15 is a diagram illustrating a part of an exemplary flow of a product activation process on target software included in an offline client PC;

FIG. 16 is a diagram illustrating a part of an exemplary flow of a product activation process on target software included in an offline client PC; and

FIG. 17 is a diagram illustrating an exemplary hardware configuration of a computer.

### DETAILED DESCRIPTION

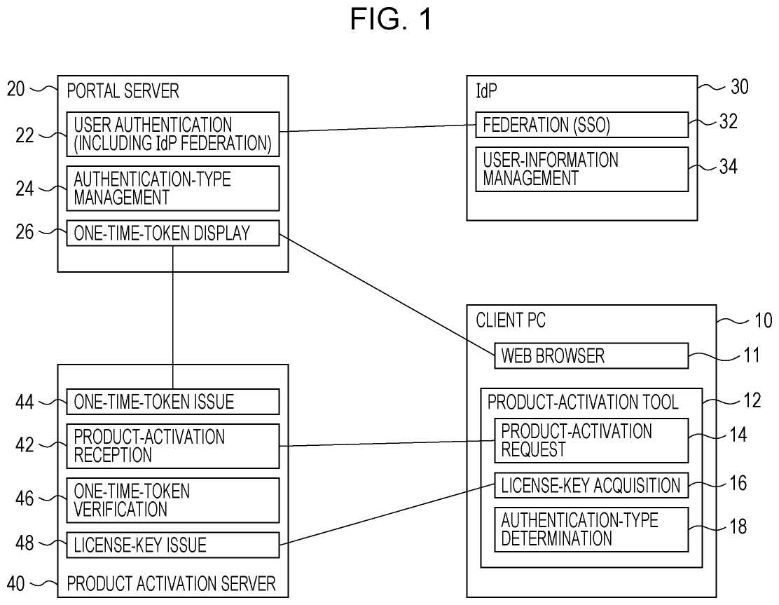

Referring to FIG. 1, an exemplary system configuration according to an exemplary embodiment will be described. The system includes a client personal computer (PC) 10, a portal server 20, an identity provider (IdP) 30, and a product activation server 40. Among these apparatuses, at least the portal server 20, the IdP 30, and the product activation server 40 are capable of communicating with each other, for example, over a network.

The client PC 10 is a personal computer used by a user. In the client PC 10, software (hereinafter called “target software”, and not illustrated) under license management conducted by the product activation server 40 is installed. In addition, in the client PC 10, a web browser 11 and a product-activation tool 12 are installed.

The web browser 11 is used to browse web pages on the World Wide Web (WWW).

The product-activation tool 12 is software for conducting license management of the target software installed in the client PC 10. On the basis of data called a license key or license code (hereinafter collectively referred to as a “license key”), the product-activation tool 12 manages execution of the target software on the client PC 10 or the user's use permission for the target software. For example, in most cases, the product-activation tool 12 does not permit execution of the target software when the client PC 10 does not have a license key corresponding to the target software (As a matter of course, there may be some exceptions, such as permitting the first execution of the target software or permitting the execution in a period of predetermined length after that). A license key of the target software is issued by the product activation server 40, and is held in the client PC 10 under management of the product-activation tool 12.

For such management of execution of the target software based on a license, the product-activation tool 12 has a product-activation request 14 function and a license-key acquisition 16 function. In addition, the product-activation tool 12 may have an authentication-type determination 18 function.

The product-activation request 14 function is to request a license key of the target software. In the state in which the client PC 10 is connected to a network such as the Internet, that is, when the client PC 10 is online, the product-activation request 14 function is to request the product activation server 40, which is on the network, to activate the target software, and obtain the license key in response to the request. When the client PC 10 is not permitted to be connected to a network, the product-activation request 14 function is to output a file (which is a product-activation information file described below) including data necessary for the product activation server 40 to perform product activation.

The license-key acquisition 16 function is to acquire a license key issued by the product activation server 40 and store the license key in a nonvolatile storage device of the client PC 10. When the client PC 10 is online on a network, the license-key acquisition 16 function is to receive a license key, which is issued by the product activation server 40, online for acquisition. The license-key acquisition 16 function of the offline client PC 10 is to acquire a license key stored in a portable recording medium such as a Universal Serial Bus (USB) memory.

The authentication-type determination 18 function is to determine the authentication type of a user which describes a user authentication system necessary to receive the service of the product activation server 40. This determination is made through reception of specification of the user's authentication type from the user.

The portal server 20 is prepared as a contact, which is provided by a company offering the target software to users, for service to users. The portal server 20 provides web pages for various services, for example, through web-server functions. The portal server 20 also serves as a contact for product activation service for the target software.

In the exemplary embodiment, the client PC 10, having the target software installed therein, is a personal computer. However, this is merely exemplary. The client PC 10 may be a computer other than a personal computer, such as a smartphone, a tablet terminal, a multifunction device, or a kiosk terminal.

The portal server 20 has a function of performing user authentication 22 on users who are going to use the services. The user authentication function is to perform user authentication, for example, by receiving input of authentication information, such as a user ID (“ID” indicates identification information) and a password, from a user, and checking whether the authentication information matches the user's authentication information stored in the portal server 20. This type of user authentication is called a specific authentication system. To receive user authentication through the specific authentication system, a user needs to have received assignment of a user ID from the portal server 20 and have registered authentication information, such as a password or their fingerprint, corresponding to the user ID.

The user authentication 22 function is to accept single sign-on using authentication performed by a given IdP 30 which is present outside the portal server 20. That is, when a user is authenticated by a given IdP 30, the user is permitted to log in the portal server 20 and the product activation server 40 in response to the success of authentication. “Sign-on” has the same meaning as “login”, and “sign-in” and “logon” may be also used. Hereinafter, the term, “login”, is used. “Sign-on” is used in “single sign-on”. The user authentication 22 performs federation with an external, given IdP 30 based on a standard, such as Security Assertion Markup Language (SAML) or OpenID. Such an authentication system for getting access to the portal server 20 through single sign-on in accordance with user authentication performed by an external IdP 30 is called a federation system.

A user may log in the portal server 20 by using either one of the specific authentication system and the federation system.

The portal server 20 further has an authentication-type management 24 function and a one-time-token display 26 function.

The authentication-type management 24 function is to manage information describing the type of user authentication system for each of individual users registered with the portal server 20, that is, information describing which system, the specific authentication system or the federation system, is to be used by each user as a user authentication system. When a user is to log in the portal server 20, the user is authenticated through the system indicated by the authentication type managed by the authentication-type management 24.

The one-time-token display 26 function is to display, to a user, a one-time token issued by the product activation server 40 for product activation. For example, this function causes a web page, which displays a one-time token, to be provided to the web browser 11 used by the user.

A one-time token is temporary information issued by the product activation server 40 to a user who has succeeded in user authentication performed by the portal server 20 (including the case of use of federation with the IdP 30). A one-time token is information indicating that user authentication has succeeded. A one-time token is exemplary token information.

The IdP 30 is an apparatus (for example, a server) responsible for functions of an identity provider for single sign-on, and is an exemplary user-authentication apparatus. The IdP 30 has a federation 32 function and a user-information management 34 function. The user-information management 34 function is to manage information, which is necessary for user authentication of a user who is going to log in the IdP 30, such as authentication information, for example, a user ID and a password. It is assumed that a user, who uses the federation system, has been given a user ID from the IdP 30 and has registered authentication information such as a password with the IdP 30. The IdP 30 refers to information managed by the user-information management 34, and performs user authentication.

The federation 32 function is to provide a user authentication result, which is produced by the IdP 30, to the user authentication 22 of the portal server 20, for example, through a system based on SAML or OpenID.

FIG. 1 illustrates only one IdP 30. Alternatively, there may be multiple IdPs 30 federated with the portal server 20.

The product activation server 40 authenticates activation of the target software. For example, the product activation server 40 issues a license key in response to a request from a user who has been authenticated (including the case of authentication through federation with the IdP 30) by the portal server 20. The product activation server 40 has a product-activation reception 42 function, a one-time-token issue 44 function, a one-time-token verification 46 function, and a license-key issue 48 function. A license key is exemplary license information indicating presence of a license of the target software.

The product-activation reception 42 function is to receive, from a user, a request to activate the target software, and determine whether the user has a license of the target software. The one-time-token issue 44 function is to issue a one-time token which is to be given to a user. The one-time-token verification 46 function is to verify a one-time token presented by a user. The license-key issue 48 function is to issue a license key of the target software to a user.

A pair of the portal server 20 and the product activation server 40 is an exemplary information processing apparatus according to the exemplary embodiment. As another example, instead of a pair of the portal server 20 and the product activation server 40, a single information processing apparatus or information processing system having the functions of both the apparatuses may be provided. Alternatively, either or both of the portal server 20 and the product activation server 40 may be implemented through distributed processing using multiple computers.

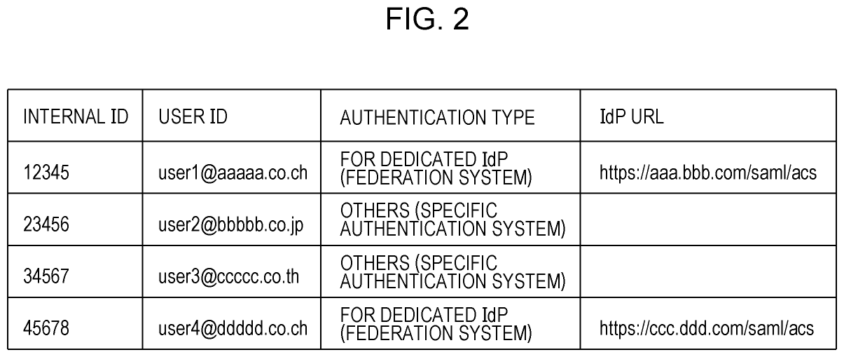

FIG. 2 illustrates exemplary authentication-type information managed by the authentication-type management 24 of the portal server 20. The illustrated authentication-type information includes items of the internal ID, the user ID, the authentication type, and the IdP uniform resource locator (URL) for each user.

The internal ID is identification information provided internally by the portal server 20 to the user. The internal ID is a unique value in the portal server 20.

The user ID is identification information of the user. In the case of a user using the specific authentication system, the user ID is identification information registered by the user with the portal server 20. In the case of a user using the federation system, the user ID is identification information of the user in the IdP 30 performing federation operations. In the example in FIG. 2, both in the case of the specific authentication system and in the case of the federation system, an electronic mail address of the user is used as their user ID. Needless to say, the user ID may be other than the electronic mail address.

The authentication type is information indicating whether the user authentication system of the user is the specific authentication system or the federation system.

The IdP URL is a URL of the IdP 30 with which the user uses the federation system. For users using the specific authentication system, the IdP URL item is blank.

In addition to the authentication-type information, the portal server 20 stores and manages authentication information such as passwords of users using the specific authentication system (not illustrated).

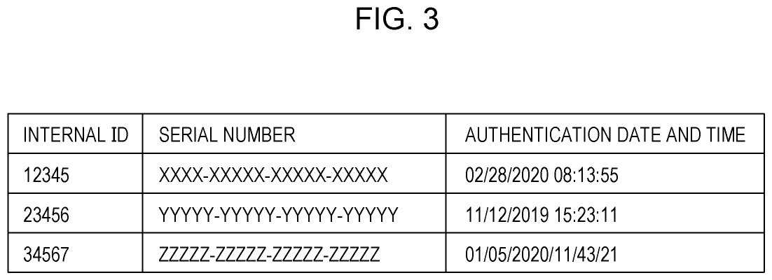

FIG. 3 illustrates exemplary license management information managed by the product activation server 40. The license management information includes items of the internal ID, the serial number, and the authentication date and time. The internal ID is identification information provided internally by the portal server 20 to the user. The internal ID is the same as that in the authentication-type information (see FIG. 2) in the portal server 20. The serial number is a serial number of the target software for which a license is to be issued. The authentication date and time is a date and time when product activation was authenticated (that is, a license key was issued). The record in the first line in FIG. 3 means that a license key of the target software, whose serial number is “XXXX-XXXXX-XXXXX-XXXXX”, was issued to the user, whose internal ID is “12345”, at 8:13:55 am on Feb. 28, 2020.

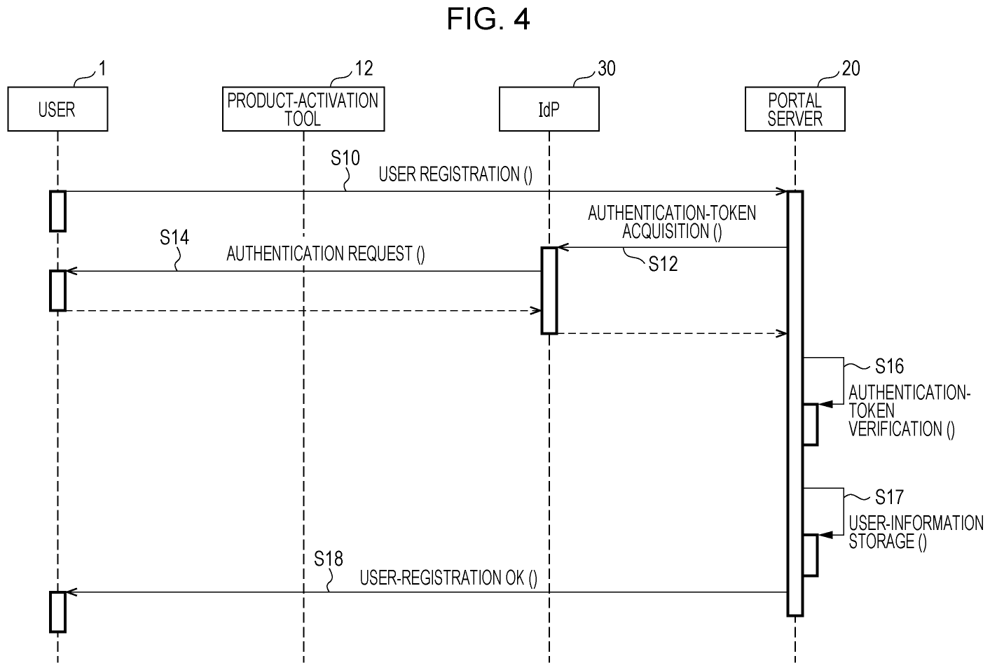

Referring to FIG. 4, an exemplary procedure of registering a user, who wants to use the federation system, with the portal server 20 in the system will be described.

In this procedure, a user 1 accesses a web page for user registration with the portal server 20 from the web browser 11 and starts the user registration process (S10). The web page includes a graphical user interface (GUI) for selecting the specific authentication system or the federation system as an authentication system, and a GUI for selecting an IdP 30 used in the case of the federation system (not illustrated). In this example, the user 1 selects the federation system on the web page, and selects an IdP 30 used in authentication. In response to the selection, the portal server 20 redirects the user 1 to the federation 32 function of the selected IdP 30, and tries to obtain an authentication token (S12).

The federation 32 function of the IdP 30 is used to transmit an authentication request to the user 1 (S14). If the user 1 has not logged in the IdP 30 from the web browser 11, the federation 32 function is used to prompt the user 1 to login to the IdP 30 in S14. In response to this, the user 1 inputs a user ID and authentication information. When user authentication succeeds by using the input, the IdP 30 permits the user 1 to log in, and returns an authentication token to the portal server 20. If, in the web browser 11, the IdP 30 has been already logged in at the time point of the authentication request (S14), for example, the IdP 30 provides, to the user 1, a web page for transmitting an inquiry about whether offering an authentication token to the portal server 20 is to be permitted. When, in response to the inquiry, the user 1 provides an input indicating that offering an authentication token is to be permitted, the IdP 30 returns an authentication token to the portal server 20. The authentication token includes the user ID of the user 1 which is registered with the IdP 30, and data indicating that the IdP 30 has authenticated the user 1.

The portal server 20, which has received the authentication token from the IdP 30, verifies whether the authentication token is valid according to a standard for federation such as SAML (S16). The example in FIG. 4 assumes that the authentication token is valid. In this case, the portal server 20 assigns a unique internal ID to the user 1. The portal server 20 registers, in the authentication-type information (see FIG. 2), the internal ID, the user ID of the user 1 used in the IdP 30, the value, “federation system”, indicating the authentication type, and the URL of the IdP 30 (S17). The portal server 20 provides, to the web browser 11 operated by the user 1, a web page indicating completion of the user registration (S18), and ends the series of user registration process.

### In the Case of Online

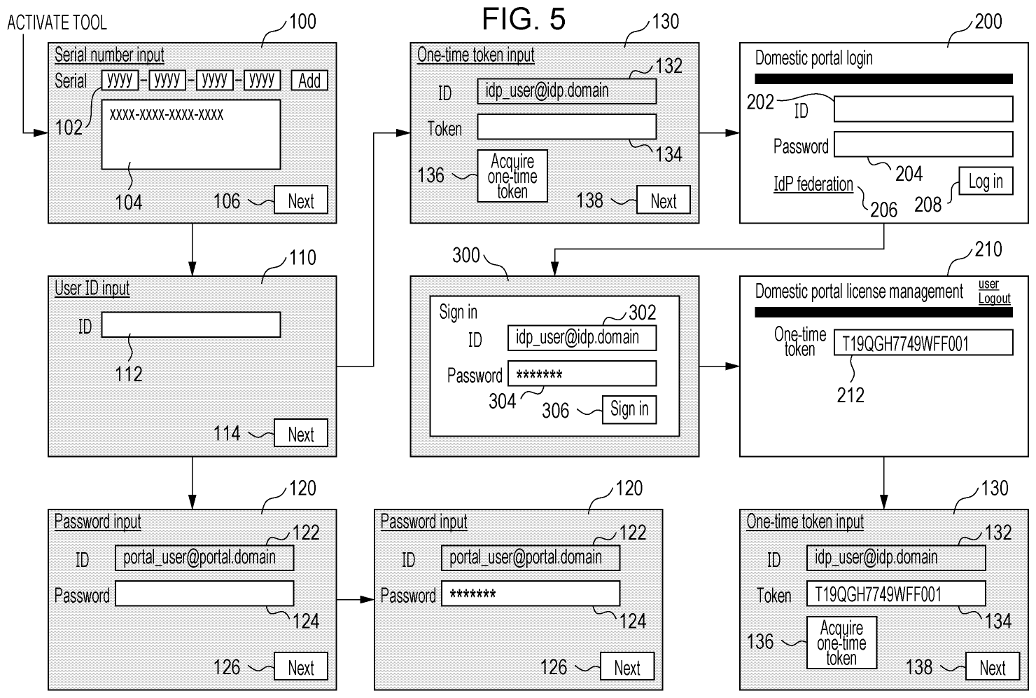

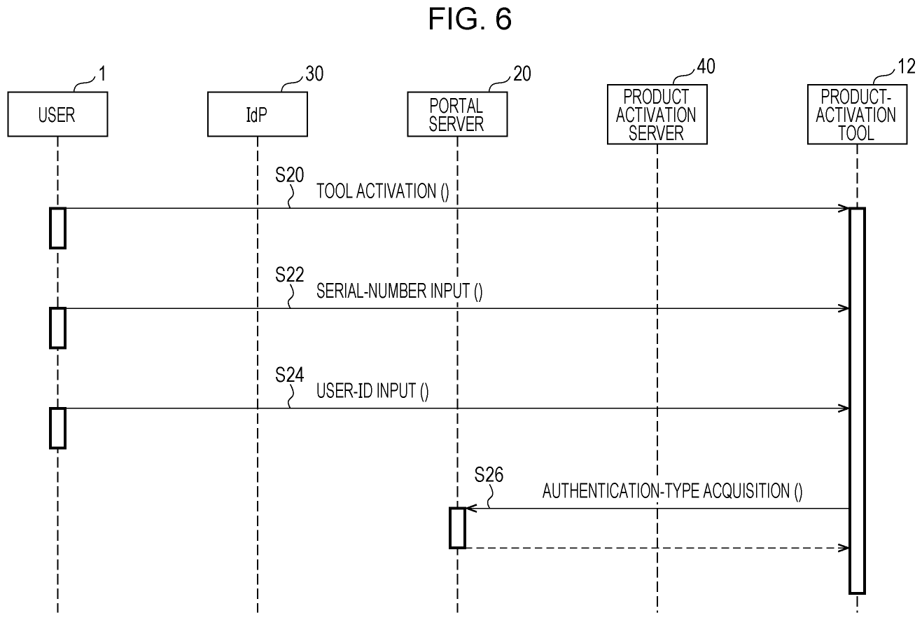

Referring to FIGS. 5 and 6 to 9, an exemplary flow of a product activation process on the target software installed in an online client PC 10 will be described. FIG. 5 illustrates exemplary transitions of user interface (UI) screens provided to the user 1 in the process flow. FIGS. 6 to 9 are sequence charts corresponding to four divisions constituting the process flow.

In this process, as illustrated in FIG. 6, the user 1 activates the product-activation tool 12 on the client PC 10 (S20). The activated product-activation tool 12 uses the product-activation request 14 function to generate a serial-number input screen 100 and display the serial-number input screen 100 on the display apparatus of the client PC 10. The serial-number input screen 100 is the top screen in the left column among the 3×3 screens illustrated in FIG. 5. The user 1 enters the serial number of the target software that is to be activated this time, in an input field 102 on the serial-number input screen 100 (S22). When the user 1 enters the serial number in the input field 102 and presses an “Add” button on the right of the field, the input serial number is added, for display, to a list display field 104. For example, in the serial-number input screen 100 illustrated in FIG. 5, the serial number, “XXXX-XXXX-XXXX-XXXX”, of a certain piece of target software has been already entered. The serial number, “yyyy-yyyy-yyyy-yyyy”, of a different piece of target software has been entered in the input field 102. When the “Add” button is pressed, the number in the input field 102 is moved to the list display field 104. The product-activation tool 12 uses the product-activation request 14 function to store one or more serial numbers, which are listed in the list display field 104, as target numbers for product activation.

Upon completion of entering of the serial numbers of all pieces of target software that are to be activated this time, the user 1 presses a “Next” button 106. In response to pressing the button, the product-activation request 14 function is used to display a user-ID input screen 110 (that is, the center screen in the left column in FIG. 5) on the display apparatus of the client PC 10. The user 1 enters their user ID in an ID field 112 on the user-ID input screen 110 (S24), and presses a “Next” button 114.

In response to this, the product-activation request 14 function is used to acquire the authentication type from the portal server 20 over the network (S26). In the acquisition process, the product-activation request 14 function is used to transmit, to the portal server 20, an acquisition request including the input user ID. The portal server 20 reads, from the authentication-type information (see FIG. 2), authentication-type information which indicates a user authentication system and which corresponds to the user ID included in the acquisition request, and returns the authentication-type information to the product-activation tool 12.

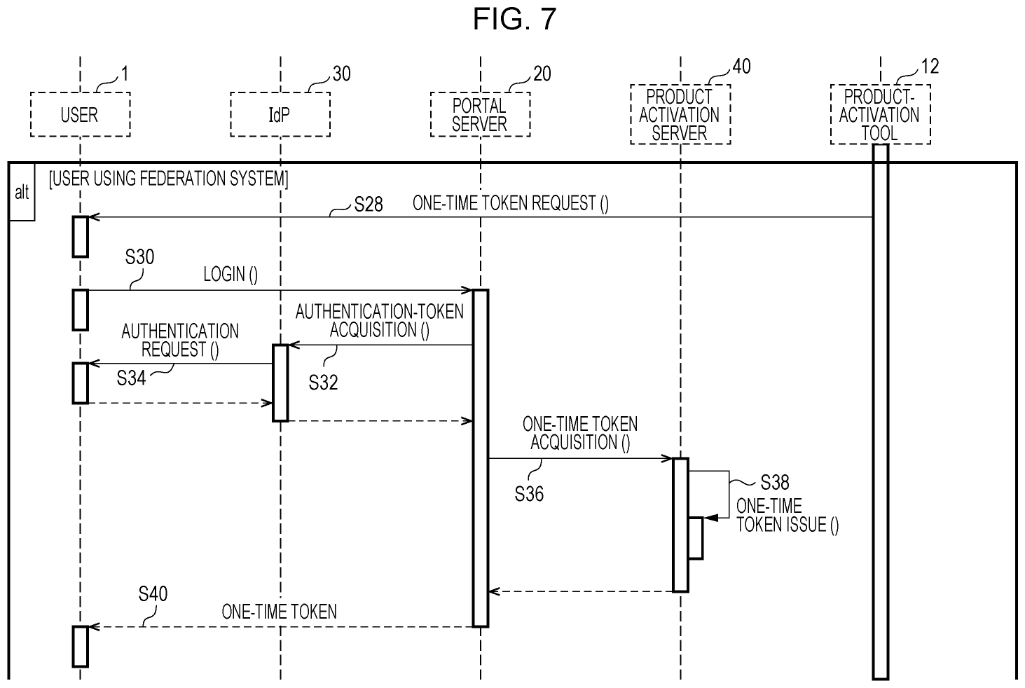

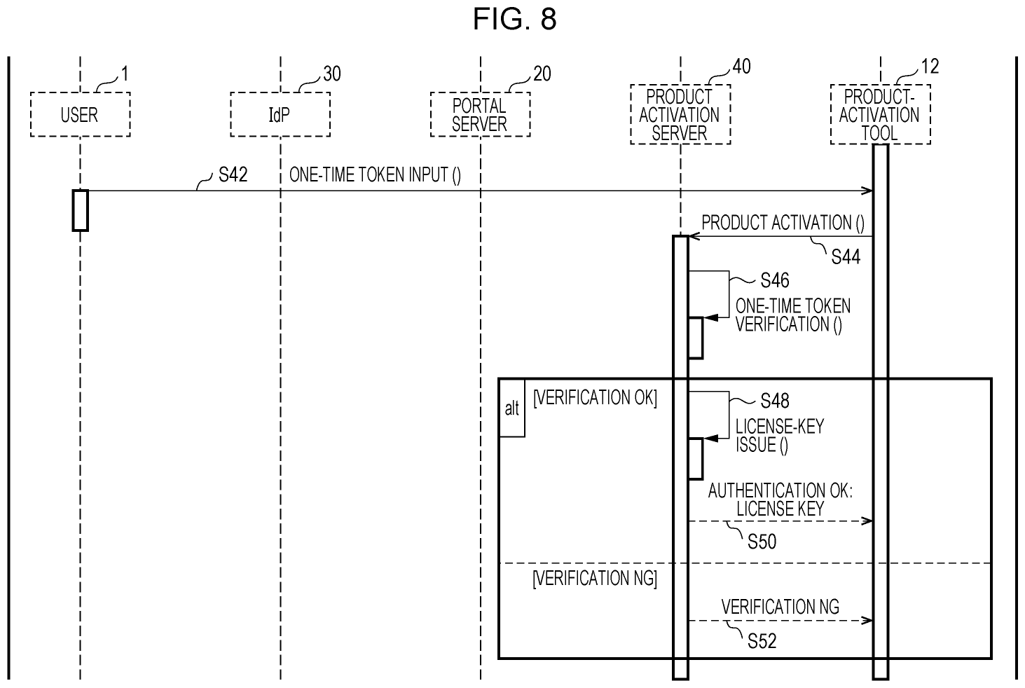

The process after that depends on whether the authentication type of the user 1 is the specific authentication system or the federation system. The process performed in the case where the authentication type of the user 1 is the federation system will be described by referring to FIGS. 7 and 8.

In this process, as illustrated in FIG. 7, the product-activation tool 12 displays a one-time token input screen 130 on the display apparatus of the client PC 10, and thus prompts the user 1 to input a one-time token (S28).

The top screen in the center column in FIG. 5 is an exemplary one-time token input screen 130. The one-time token input screen 130 includes an ID field 132, a token input field 134, an acquisition button 136, and a “Next” button 138. In the ID field 132, the user ID, which has been entered by the user 1 in the ID field 112 of the user-ID input screen 110, is displayed. In the token input field 134, the user 1 enters a one-time token issued by the product activation server 40. The user 1 presses the acquisition button 136 to request acquisition of a one-time token. After the user 1 who has acquired a one-time token enters the token in the token input field 134, the user 1 presses the “Next” button 138 to proceed the process. At the time point of S28, a one-time token has not been issued. Thus, the token input field 134 is blank.

The user 1 presses the acquisition button 136. In response to this, the product-activation tool 12 activates the web browser 11 to open a login page 200 of the portal server 20 (S30). The top screen in the right column in FIG. 5 is an exemplary login page 200 displayed on the display apparatus of the client PC 10 at that time. In the login page 200, a link 206 to a login page of the IdP 30 is displayed in addition to an ID field 202 and a password input field 204. In S30, for example, the user ID may be transmitted to the portal server 20, for example, by using a method of including the user ID, which has been entered in the ID field 132, as a parameter in a Hypertext Transfer Protocol (HTTP) request requesting the login page 200. In this case, the user ID may be automatically input to the ID field 202 of the login page 200.

When there are multiple IdPs 30 corresponding to the portal server 20, the links 206 to the login pages of the individual IdPs 30 may be displayed in a selective manner in the login page 200. In this case, the user 1 selects, for click, the link to the IdP 30 that is used by the user 1, from the multiple links.

As another example, only one link 206 indicating the IdP URL for the user 1 which is registered in the authentication-type information (see FIG. 2) may be displayed in the login page 200. To do this, for example, the user ID is transmitted from the product-activation tool 12 to the portal server 20 in acquisition of the authentication type in S26 or in access to the login page 200 in S30. The portal server 20 reads, from the authentication-type information, the IdP URL corresponding to the user ID, and embeds the URL in the link 206 in the login page 200.

The user 1 clicks the link 206 to the login page of the IdP 30 used by the user 1.

In response to this click, the portal server 20 transmits a request to obtain an authentication token, to the IdP 30 indicated by the clicked link (S32), and redirects the web browser 11 to a login page 300 of the IdP 30 (S34). The login page 300 of the IdP 30 is illustrated at the center of the center column in FIG. 5. The user 1 enters their user ID and password in an ID field 302 and a password input field 304 of the login page 300. Alternatively, the user ID (for example, the user ID which has been automatically input to the login page 200) may be transmitted from the web browser 11 to the IdP 30 in redirection. In this case, the IdP 30 automatically inputs the user ID to the ID field 302 of the login page 300, and the user 1 enters only their password in the password input field 304.

After that, the user 1 presses a “Sign-in” button 306. In response to this pressing, the IdP 30 determines whether the pair of the user ID and the password in the ID field 302 and the password input field 304 is valid. If the IdP 30 determines that the pair is valid, the IdP 30 permits the user 1 to log in (that is, sign-in), and returns an authentication token to the portal server 20 from which the request has been transmitted. The authentication token includes information about the user ID of the user 1 who has been authenticated.

The portal server 20, which has received the authentication token, permits the user 1 to log in the portal server 20, and transmits, to the product activation server 40, a request to acquire a one-time token (S36). The acquisition request includes information of the user ID indicated by the authentication token. In addition, the acquisition request may include the serial number of the target software. In this case, for example, the serial number may be provided from the product-activation tool 12 to the portal server 20 in acquisition of the authentication-type information in S26.

The product activation server 40, which has received, from the portal server 20, the request to acquire a one-time token, uses the one-time-token issue 44 function to issue a one-time token in which a given effective period is specified (S38). The one-time-token issue 44 function is used to store the one-time token in association with the user ID, which is included in the acquisition request, and the effective period, and transmit the one-time token to the portal server 20, which has transmitted the acquisition request, as a response.

The portal server 20, which has received the one-time token as a response, uses the one-time-token display 26 function to display a web page 210, which displays a one-time token 212, in the web browser 11 of the user 1 as a response (S40). The web page 210, which is displayed as a response, is, for example, like the center screen in the right column in FIG. 5.

The process proceeds to the sequence illustrated in FIG. 8. The user 1 enters the one-time token 212 in the web page 210 in the token input field 134 of the one-time token input screen 130, for example, through a copy-and-paste operation. The state of the one-time token input screen 130 after this input is illustrated as the bottom screen in the right column in FIG. 5. After input of the one-time token to the token input field 134, the user 1 presses the “Next” button 138 (S42). Thus, the product-activation tool 12 receives the input one-time token. The product-activation tool 12 transmits, to the product activation server 40, a product-activation request including the received one-time token, the serial number obtained in S22, and the user ID obtained in S24 (S44). The process in S44 is an exemplary output process of outputting token information and user identification information of a user in association with each other.

The product activation server 40 uses the one-time-token verification 46 function to verify the one-time token included in the received product-activation request (S46). In the verification in S46, the product activation server 40 determines whether the pair of one-time token and user ID in the product-activation request corresponds to one of the pairs of one-time token and user ID which are stored in the product activation server 40 and which are within their effective periods. If the determination result is positive (that is, “there is a corresponding pair”), the user 1 indicated by the user ID is a user who is allowed to access the portal server 20 (and eventually the product activation server 40) through the user authentication performed by the IdP 30. In this case, the product activation server 40 further determines whether a license key of the target software indicated by the serial number included in the product-activation request is to be provided to the user ID. The determination may be made through a method similar to one in the related art, for example, through a method such as determination about whether the user ID corresponds to a user in a customer company which has purchased the license for the serial number and whether there remain unused sub-licenses of the license purchased by the customer company. If both the verification of the one-time token and the determination about whether a license key is to be issued to the user 1 succeed, the product activation server 40 determines success of verification, that is, “verification OK”. If not, the product activation server 40 determines failure of verification, that is, “verification NG”.

If the product activation server 40 determines verification OK, the product activation server 40 uses the license-key issue 48 function to issue a license key (S48). At that time, the product activation server 40 adds, to the license management information (see FIG. 3), information for recording the issue, that is, a set of the internal ID corresponding to the user ID, the serial number, and the date and time of the issue (that is, the “authentication date and time”). The product activation server 40 returns, to the product-activation tool 12, information indicating authentication OK, and the license key as a response to the product-activation request in S44 (S50). After that, the product-activation tool 12 uses the license-key acquisition 16 function to acquire the license key received from the product activation server 40 and store the license key in a nonvolatile storage device of the client PC 10 (not illustrated). After that, in activation of the target software, the product-activation tool 12 confirms storage of the license key corresponding to the target software, and then activates the target software.

If the product activation server 40 determines verification NG in S46, the product activation server 40 returns, to the product-activation tool 12, information indicating authentication NG as a response to the product-activation request in S44 (S52). In response to this, the product-activation tool 12 displays a screen indicating failure of product activation, and the process ends.

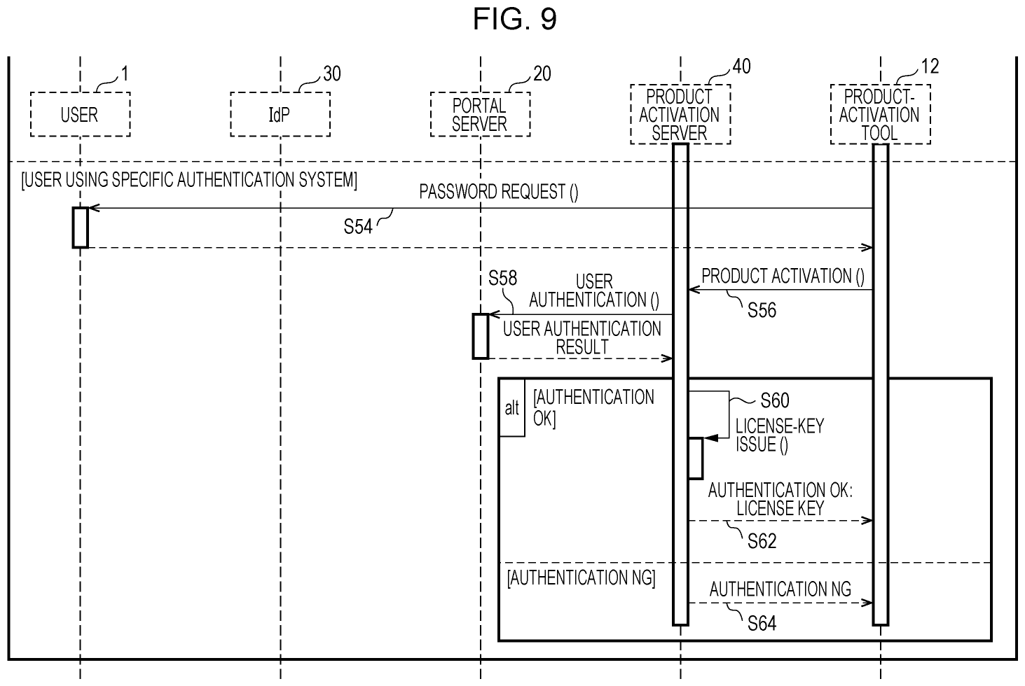

The process flow in the case where the authentication type of the user 1, which is obtained in S26, is the specific authentication system will be described by referring to FIG. 9.

In this case, the product-activation tool 12 displays a password input screen 120 illustrated at the bottom in the left column in FIG. 5, and prompts the user 1 to input a password (S54). A user ID, which has been already entered, is displayed in an ID field 122 of the password input screen 120. The user 1 enters a password in a password input field 124 which is blank (see the screen at the bottom in the center column in FIG. 5), and presses a “Next” button 126. In response to this pressing, the product-activation tool 12 transmits, to the product activation server 40, a product-activation request including the input password and the user ID (S56).

The product activation server 40 transmits, to the portal server 20, the pair of user ID and password which is included in the product-activation request, and requests user authentication (S58). In response to the request, the portal server 20 checks if the pair of user ID and password has been registered with the portal server 20. If the pair has been registered, the portal server 20 determines success of user authentication, that is, “authentication OK”. If not, the portal server 20 determines failure of user authentication, that is, “authentication NG”. The portal server 20 transmits the authentication result to the product activation server 40 as a response.

The product activation server 40, which has received the response indicating authentication OK, uses the license-key issue 48 function to issue a license key and return a response indicating authentication OK and including the license key, to product-activation tool 12 as in S48 and S50 described above (S62). The product-activation tool 12 acquires the license key for storage.

If the product activation server 40 receives a response indicating authentication NG, the product activation server 40 returns information indicating authentication NG, to the product-activation tool 12 as a response to the product-activation request in S56 (S64). In response to this, the product-activation tool 12 displays a screen indicating failure of product activation, and the process ends.

### In the Case of Offline

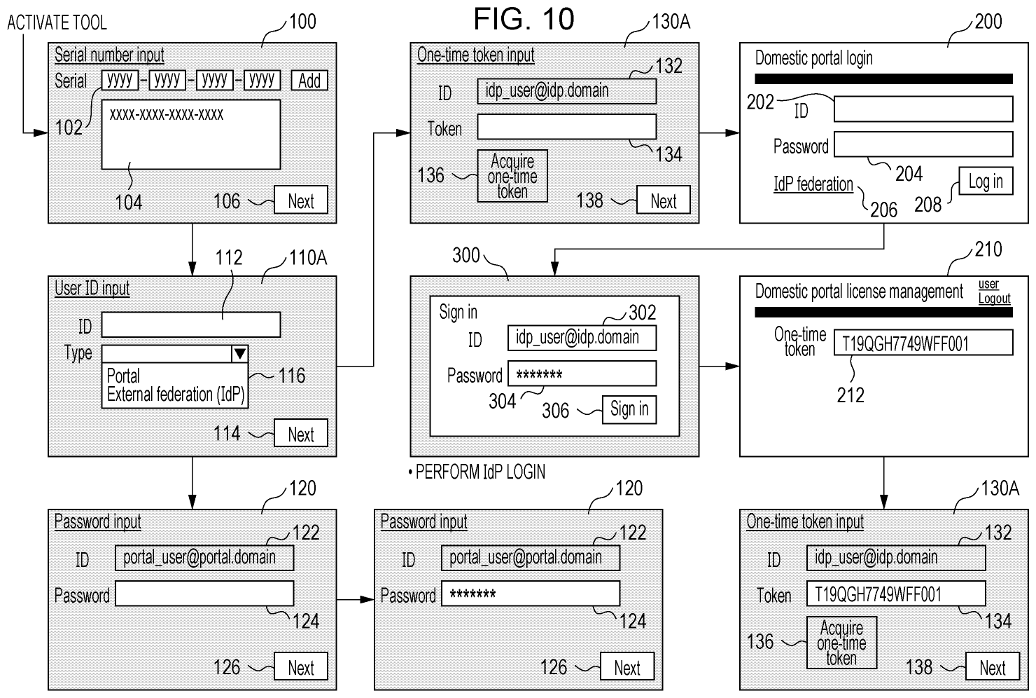

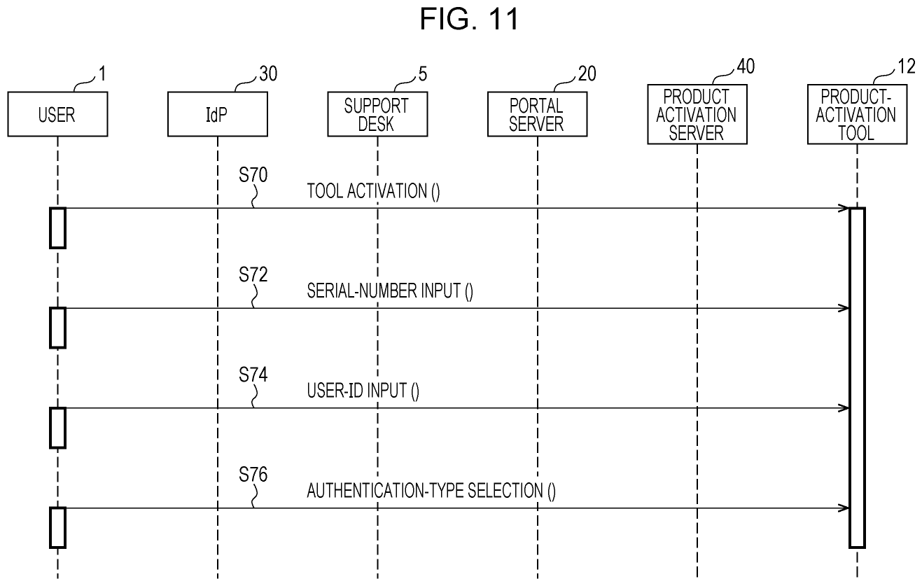

Referring to FIGS. 10 and 11 to 16, an exemplary flow of a product activation process on the target software installed in an offline client PC 10 will be described. FIG. 10 illustrates exemplary transitions of UI screens provided to the user 1 in the process flow. FIGS. 11 to 16 are sequence charts corresponding to six divisions constituting the process flow. Frequently, for example, due to information security reasons, some client PCs 10 in an organization such as a company are operated without connection to networks (that is, in the offline state).

When the client PC 10, having the target software installed therein, is offline, it is not possible to access the portal server 20, the IdP 30, and the product activation server 40 over a network from the client PC 10. Therefore, to activate the target software, the user 1 needs to use an online PC different from the client PC 10 to access the portal server 20, the IdP 30, and the product activation server 40. Therefore, in the example illustrated in FIGS. 10 and 11 to 16, PCs operated by the user 1 include an offline client PC 10, having the target software installed therein, and a PC (referred to as an “online PC”) which is online and which is different from the offline client PC 10. In this example, for convenience sake, it is called an “online PC”. The online PC may be a computer other than a personal computer, such as a smartphone, a tablet terminal, a multifunction device, or a kiosk terminal.

In this example, the operation manager of the product activation server 40 prepares a support desk 5. The user 1 obtains a license key of the target software through communication using a communication system such as electronic mail with the support desk 5.

The process flow will be described. As illustrated in FIG. 11, the user 1 activates the product-activation tool 12 on the client PC 10 (S70). The product-activation tool 12 displays the serial-number input screen 100, which is illustrated at the top in the left column in FIG. 10, on the display apparatus of the client PC 10. The user 1 enters the serial number of the target software that is to be activated this time, in the input field 102 of the serial-number input screen 100 (S72). After completion of input of the serial numbers of all pieces of the target software that are to be activated, the user 1 presses the “Next” button 106.

Upon pressing the button, the product-activation request 14 function is used to display a user-ID input screen 110A, which is illustrated in the center in the left column in FIG. 10, on the display apparatus of the client PC 10. The user-ID input screen 110A includes the ID field 112 and an authentication-type field 116. In the authentication-type field 116, options of the user authentication type are displayed in a pull-down menu. The user 1 enters their user ID in the ID field 112 of the user-ID input screen 110A (S74). The user 1 further selects their user authentication system from the pull-down menu (S76), and presses the “Next” button 114. The user 1 themselves selects their authentication type. The reason why the user 1 selects their authentication type is that the offline client PC 10 is not capable of receiving a determination result which describes the authentication type and which is made by the portal server 20.

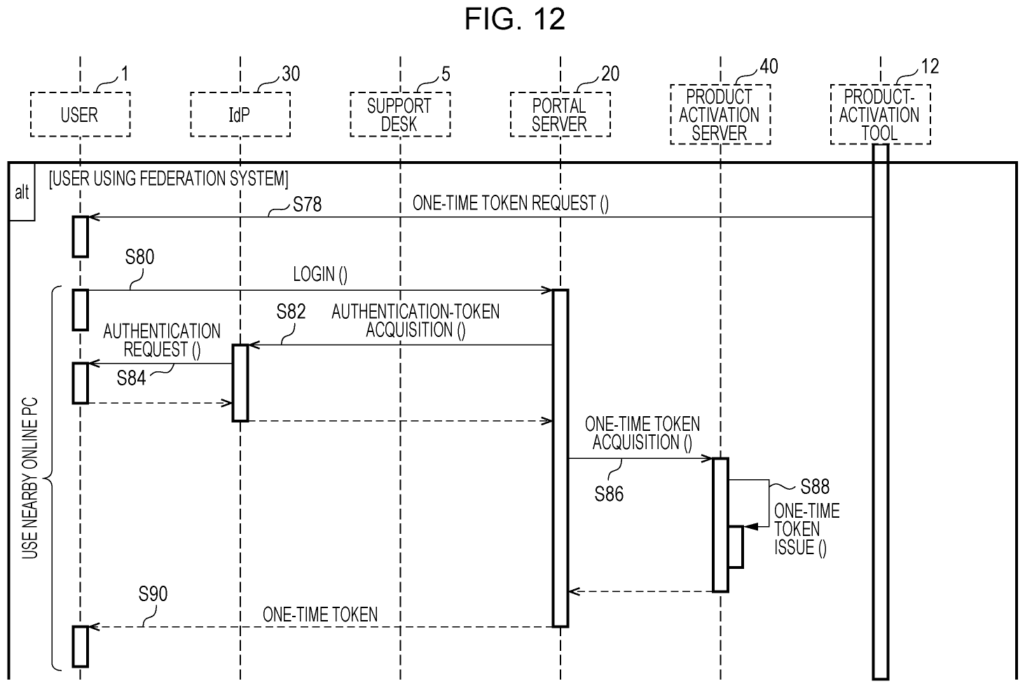

The process after that depends on whether the authentication type selected by the user 1 is the specific authentication system or the federation system. The process performed in the case where the authentication type of the user 1 is the federation system will be described by referring to FIGS. 12 to 14.

After S76, as illustrated in FIG. 12, the product-activation tool 12 displays a one-time token input screen 130A, which is illustrated at the top in the center column in FIG. 10, on the display apparatus of the client PC 10, and thus prompts the user 1 to input a one-time token (S78). The one-time token input screen 130A is similar to the one-time token input screen 130 which is displayed in the case of online and which is illustrated in FIG. 5. However, the one-time token input screen 130A is different from the one-time token input screen 130 in that the acquisition button 136 for acquiring a one-time token is displayed in gray-out which indicates that pressing of the acquisition button 136 is disabled. This is because the offline state forbids access from the product-activation tool 12 to the portal server 20 and the product activation server 40. In the one-time token input screen 130A, a guidance message such as “Access a portal server from a PC connected to the Internet, obtain a one-time token, and enter the one-time token in the token input field.” may be displayed (not illustrated).

The user 1 operates an online PC, which is different from the client PC 10 and which is online on a network, and accesses the login page 200 of the portal server 20 from a web browser of the online PC (S80). The login page 200 is illustrated at the top in the right column in FIG. 10. When there are multiple IdPs 30 corresponding to the portal server 20, the login page 200 may display the links 206 to the login pages of the individual IdPs 30 in a selectable form. In this case, the user 1 selects, for click, the link to the IdP 30 used by the user 1, from the multiple links. When the user ID is entered in the ID field 202 of the login page 200, the portal server 20 may read, from the authentication-type information (see FIG. 2), the IdP URL corresponding to the user ID, and may display only one link 206 in which the URL is embedded.

At this time point, since the user 1 employs the federation system, the user 1 clicks the link 206 to the login page of the IdP 30 used by the user 1.

In response to this click, the portal server 20 transmits an acquisition request to acquire an authentication token, to the IdP 30 indicated by the clicked link (S82). The portal server 20 redirects the web browser of the online PC to the login page 300 of the IdP 30 which is illustrated at the center in the center column in FIG. 10 (S84). The user 1 enters their user ID and password in the ID field 302 and the password input field 304 of the login page 300.

After that, the user 1 presses the “Sign-in” button 306. In response to this pressing, the IdP 30 determines whether the pair of the user ID and the password in the ID field 302 and the password input field 304 is valid. If the IdP 30 determines that the pair is valid, the IdP 30 permits the user 1 to log in, and returns an authentication token, which includes the user ID of the user 1 which has been authenticated, to the portal server 20 which has transmitted the request.

The portal server 20, which has received the authentication token, permits the user 1 to log in the portal server 20, and transmits, to the product activation server 40, a request to acquire a one-time token (S86). The acquisition request includes information about the user ID indicated by the authentication token. The acquisition request may include the serial number of the target software.

The product activation server 40, which has received, from the portal server 20, the request to acquire a one-time token, issues a one-time token in which a given effective period is specified (S88). The product activation server 40 stores the one-time token in association with the user ID included in the acquisition request and the effective period, and transmits the one-time token as a response to the portal server 20 which has transmitted the acquisition request.

The portal server 20, which has received the one-time token, transmits the web page 210 (for example, the page illustrated at the center in the right column in FIG. 10), which displays the one-time token 212, as a response to the web browser of the online PC operated by the user 1 (S90). The user 1 makes a memo of the value of the one-time token 212 by hand or by using a camera of a smartphone or the like.

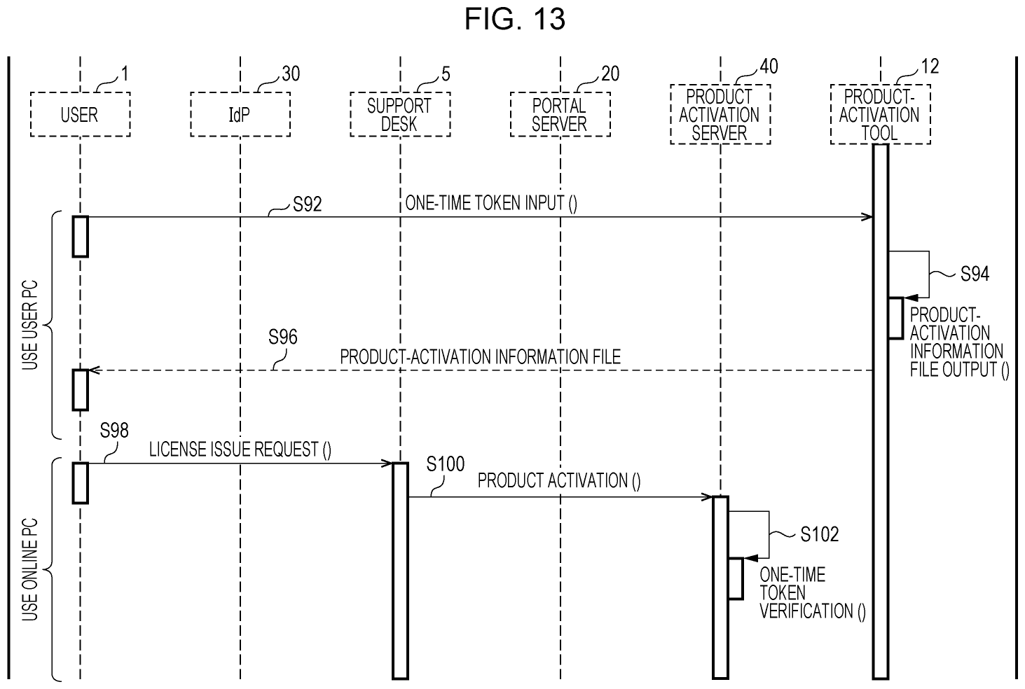

The process proceeds to the sequence illustrated in FIG. 13. The user 1 goes back to the client PC 10 used before, and enters the one-time token 212, of which a memo is made, in the token input field 134 of the one-time token input screen 130A which is displayed on the display apparatus of the client PC 10. The state of the one-time token input screen 130A after this input is illustrated as a screen at the bottom in the right column in FIG. 10. After that, the user 1 presses the “Next” button 138 (S92). Thus, the product-activation tool 12 receives the input one-time token. The product-activation tool 12 outputs a product-activation information file including the received one-time token, the serial number of the target software, which is obtained in S72, and the user ID which is obtained in S74 (S94). The process in S94 is an exemplary output process of outputting token information and user identification information of a user in association with each other. The user 1 copies the output product-activation information file from the client PC 10 to a portable device, such as a USB memory or a smartphone (S96), and goes to the online PC.

The user 1 copies or moves the product-activation information file, which is stored in the portable device, to the online PC, and uses a communication system, such as electronic mail or a messaging service, to transmit a license issue request to the support desk 5 (S98). The license issue request includes the product-activation information file.

Staff of the support desk 5 obtains the product-activation information file from the license issue request, which is received from the user 1, on the system of a PC or the like operated by the staff. The staff transmits, to the product activation server 40, a product-activation request including the product-activation information file (S100).

The product activation server 40 verifies the one-time token included in the product-activation information file in the received product-activation request (S102). In S102, the same verification as that in S46 (see FIG. 8) in activation of the target software included in the online client PC 10 is performed.

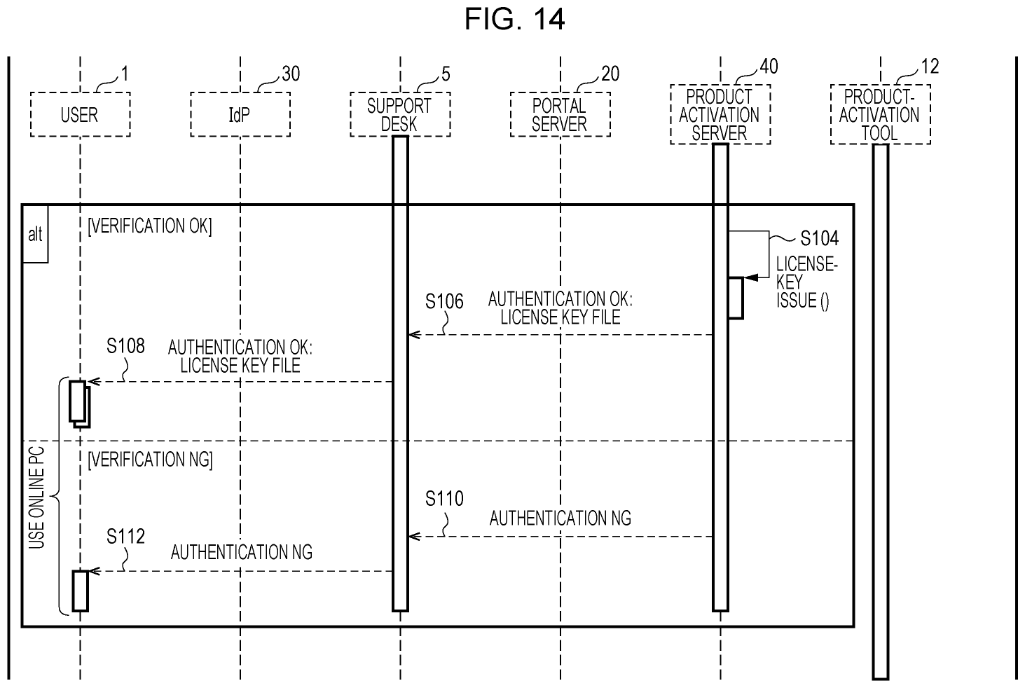

If the product activation server 40 determines verification OK in S102, the process proceeds to the processes illustrated in FIG. 14. The product activation server 40 uses the license-key issue 48 function to issue a license key (S104). At that time, the product activation server 40 adds, to the license management information (see FIG. 3), information recording the issue, that is, a set of the internal ID corresponding to the user ID, the serial number, and the date and time of the issue (that is, the “authentication date and time”). The product activation server 40 returns, to the system of the support desk 5, information indicating authentication OK and a file (referred to as a “license key file”) including the license key, as a response to the product-activation request in S100 (S106). The staff of the support desk 5 returns, to the user 1, the license key file by using the communication system such as electronic mail on the system (S108).

The user 1 copies the received license key file to a portable device, and goes to the client PC 10 (not illustrated). The user 1 copies the license key file from the portable device to the client PC 10, and uses the license-key acquisition 16 function to cause the product-activation tool 12 to obtain the license key from the file. Thus, the target software is allowed to be used under the valid license key on the client PC 10.

If the product activation server 40 determines verification NG in S102, the product activation server 40 returns, to the system of the support desk 5, information indicating authentication NG, as a response to the product-activation request in S100 (S110). In response to this, the staff of the support desk 5 returns, to the user 1, a message indicating failure of the product activation, by using a communication system such as electronic mail on the system (S112).

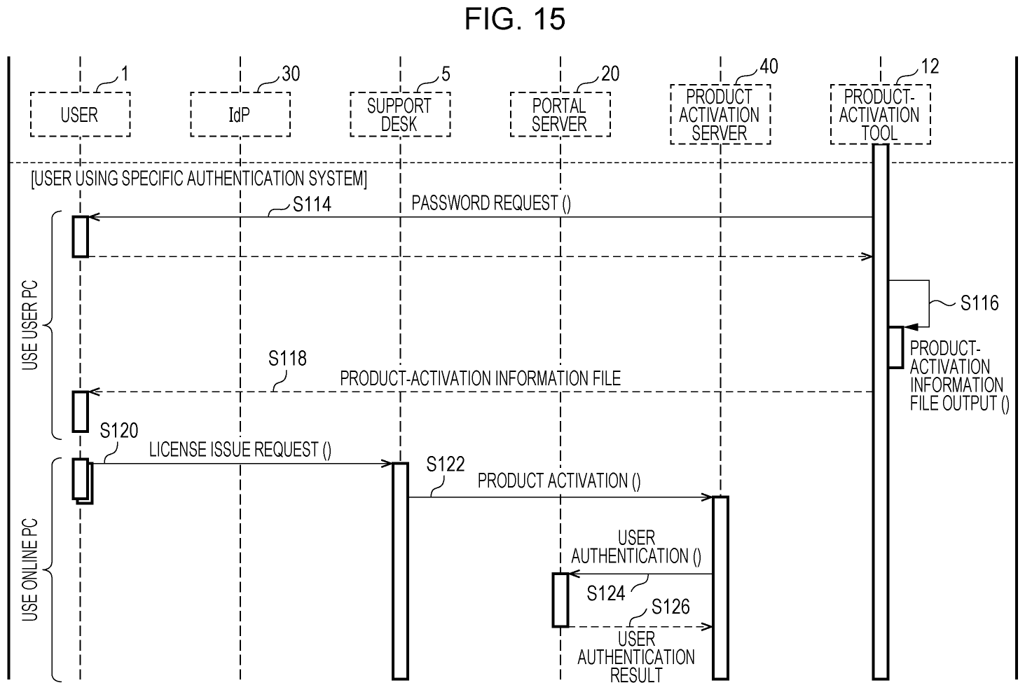

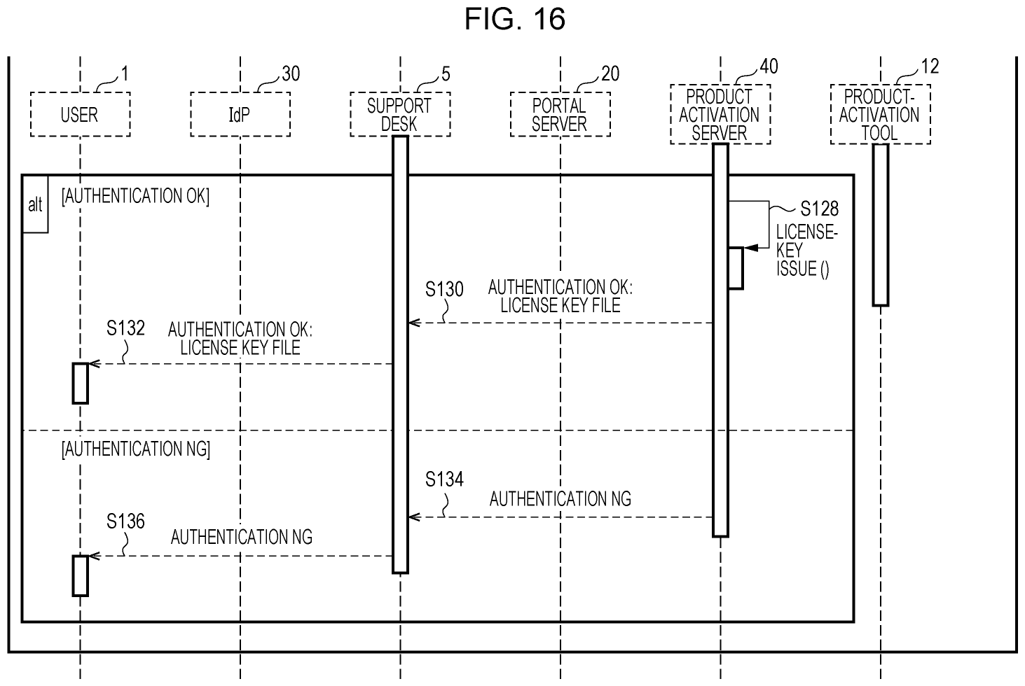

The process flow performed in the case where the authentication type of the user 1 selected in S76 is the specific authentication system will be described by referring to FIGS. 15 and 16.

In this case, the product-activation tool 12 of the client PC 10 displays the password input screen 120 illustrated at the bottom in the left column in FIG. 10, and prompts the user 1 to input a password (S114). The user 1 enters a password in the password input field 124 which is blank (see the screen at the bottom in the center column in FIG. 10), and presses the “Next” button 126. In response to this pressing, the product-activation tool 12 outputs a product-activation information file including the received password, the serial number of the target software obtained in S72, and the user ID obtained in S74 (S116). The user 1 copies the product-activation information file to a portable device (S118), and moves to the online PC.

The user 1 copies or moves the product-activation information file, which is stored in the portable device, to the online PC, and transmits a license issue request to the support desk 5 by using a communication system such as electronic mail (S120). The license issue request includes the product-activation information file.

The staff of the support desk 5 obtains the product-activation information file from the license issue request, which is received from the user 1, on the system such as a PC operated by the staff. The staff transmits, to the product activation server 40, a product-activation request including the product-activation information file (S122).

The product activation server 40 transmits, to the portal server 20, the user ID and the password included in the product-activation information file of the received product-activation request, and requests execution of user authentication (S124). In response to the request, the portal server 20 checks if the pair of user ID and password has been registered with the portal server 20. If the pair has been registered, the portal server 20 determines success of user authentication, that is, “authentication OK”. If not, the portal server 20 determines failure of user authentication, that is, “authentication NG”. The portal server 20 transmits the authentication result to the product activation server 40 as a response (S126).

As in S104 described above, the product activation server 40, which has received a response indicating authentication OK, issues a license key (S128), and returns, to the system of the support desk 5, information indicating authentication OK and a license key file including the license key (S130). The staff of the support desk 5 returns the license key file to the user 1 through a communication system such as electronic mail on the system (S132). The user 1 copies the received license key file to a portable device, and goes to the client PC 10. The user 1 copies the license key file from the portable device to the client PC 10, and uses the license-key acquisition 16 function to cause the product-activation tool 12 to obtain the license key from the file. Thus, the target software is allowed to be used under the valid license key on the client PC 10.

If the product activation server 40 receives a response indicating authentication NG in S126, the product activation server 40 returns, to the system of the support desk 5, information indicating authentication NG, as a response to the product-activation request in S122 (S134). In response to this, the staff of the support desk 5 returns, to the user 1, a message indicating failure of the product activation through a communication system such as electronic mail on the system (S136).

In the example illustrated in FIGS. 11 to 16, the staff of the support desk 5 manually handles a license issue request from the user 1. Alternatively, the operation at the support desk 5 may be performed automatically. For example, instead of the support desk 5, a server for receiving uploading of a product-activation information file may be provided. The server obtains necessary information from the uploaded product-activation information file, and requests product activation from the product activation server 40 (S100 or S122). In response to a reply from the product activation server 40 to the request, the server automatically provides a license key file to the user 1 (S108 or S132) or transmits a response indicating authentication NG (S112 or S136).

The system according to the exemplary embodiment described above is helpful, for example, in the case where transmission of data, which is generated by the client PC 10, to the outside of a country or region (hereinafter collectively referred to as a “country”), in which the client PC 10 is present, is regulated, for example, by law.

For example, the Cybersecurity Law of the People's Republic of China is an example of such a regulation. This law includes a regulation describing that “Personal information or important data gathered or produced during operations within the mainland territory of the People's Republic of China shall be stored within mainland China.” For example, when a user is registered with the portal server 20, which is present outside mainland China, from a computer such as the client PC 10 within mainland China, authentication information such as a password that is a target of restriction of export is registered with the portal server 20. This runs counter to the regulation of China. Similarly, when a product-activation information file generated by the client PC 10 includes authentication information such as a password, the file is not permitted from being transmitted to the product activation server 40 that is present outside mainland China.

To provide the user 1, who is present in a country having such a regulation, with a service from the portal server 20 and the product activation server 40 that are present outside the country, the user 1 may use the federation system using an IdP 30 that is present in the country. Such an operation enables the user 1 to log in the portal server 20 through federation with the IdP 30 even without registration of authentication information such as a password, which is prohibited from being exported, with the portal server 20. In the exemplary embodiment, a product-activation information file generated by an offline client PC 10 includes a one-time token instead of authentication information such as a password that is a target of the regulation. A one-time token, which is generated by the product activation server 40 that is present outside the country, is not a target of the regulation. In this example, a product-activation information file does not include data that is a target of the regulation. Thus, transmission of the product-activation information file from an online PC to the product activation server 40 that is present outside the country is not regulated.

Situations in which the system according to the exemplary embodiment is helpful are not limited to the case of regulations, for example, by law. For example, it is highly likely that a user, who has registered their account with an existing IdP 30, wants to use the portal server 20 and the product activation server 40 by using the account registered with the IdP 30, rather than registers a new account with the portal server 20. When an organization such as a company operates an IdP 30 for its members, it is more useful for the members of the organization to use the portal server 20 and the product activation server 40 through authentication performed by the IdP 30, than to create new accounts in the portal server 20.

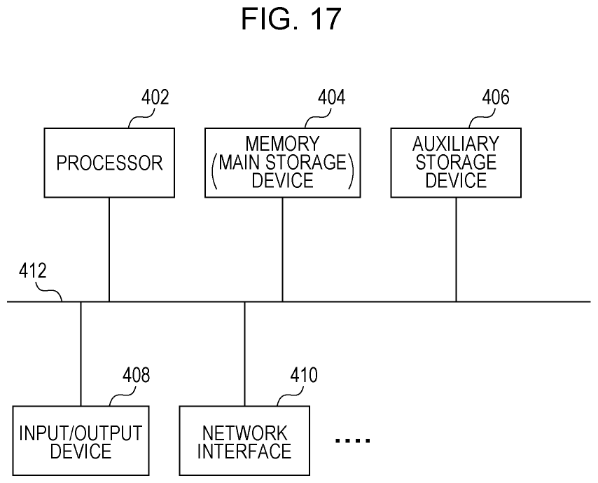

The client PC 10, the portal server 20, the IdP 30, and the product activation server 40, which are described above, are formed, for example, by using general-purpose computer hardware. FIG. 17 illustrates such an exemplary hardware configuration.

As illustrated in FIG. 17, the computer hardware has a circuit configuration in which, for example, a controller for controlling a processor 402, a memory (main storage device) 404 such as a random-access memory (RAM), and an auxiliary storage device 406 which is a nonvolatile storage device, such as a flash memory, a solid state drive (SSD), or a hard disk drive (HDD), an interface with various input/output devices 408, and a network interface 410 for controlling connection with a network such as a local-area network are connected through a data transmission line such as a bus 412. Programs describing the processes and control according to the exemplary embodiment are installed in the computer over a network or the like, and are stored in the auxiliary storage device 406. The programs stored in the auxiliary storage device 406 are executed by the processor 402 by using the memory 404. Thus, the client PC 10, the portal server 20, the IdP 30, and the product activation server 40 according to the exemplary embodiment are implemented.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a storage device that stores, for each user, information about a user-authentication apparatus corresponding to the user; and
a processor configured to:
in response to a first user asking for token information for product activation, request a first user-authentication apparatus to authenticate the first user, the first user-authentication apparatus being identified to correspond to the first user by the information stored in the storage device;
in response to reception of information indicating successful authentication of the first user from the first user-authentication apparatus as a response to the request, issue the token information to the first user; and,
in response to reception of token information input from the first user, control whether to issue license information to the first user based on a determination whether the token information input from the first user matches the token information that has been issued to the first user.

2. The information processing apparatus according to claim 1,
wherein the storage device further stores, for each user, authentication-type information indicating an authentication type describing which apparatus, the information processing apparatus or the user-authentication apparatus corresponding to the user, is to authenticate the user, and
wherein the processor is configured to:
when the authentication-type information indicates that the first user corresponds to a type of the user authentication performed by the information processing apparatus, receive input of authentication information from the first user so as to perform user authentication, and control whether to issue the license information to the first user in accordance with whether the user authentication has succeeded.

3. An information processing system comprising:
a first information processing apparatus including a first processor; and
a second information processing apparatus including a second processor and a storage device,
wherein the first processor is configured to:
prompt a first user to obtain token information for product activation from the second information processing apparatus, the first user asking for the product activation;
in response to reception of token information input from the first user, perform an output process of outputting the token information input from the first user to the second information processing apparatus in association with identification information of the first user; and
receive, for storage, license information from the second information processing apparatus, the license information being issued to the first user by the second information processing apparatus in response to the token information that has been output in the output process,
wherein the storage device stores, for each user, information about a user-authentication apparatus corresponding to the user, and
wherein the second processor is configured to:
in response to the first user asking for the token information, request a first user-authentication apparatus to authenticate the first user, the first user-authentication apparatus being identified to correspond to the first user by the information stored in the storage device;
in response to reception of information indicating successful authentication of the first user from the first user-authentication apparatus as a response to the request, issue the token information to the first user; and,
perform a control process of controlling whether to issue the license information to the first user based on a determination whether the token information input from the first user matches the token information that has been issued to the first user.

4. The information processing system according to claim 3,
wherein, when the first information processing apparatus is incapable of communicating with the second information processing apparatus, the output process outputs a file including the token information and the identification information of the first user, and
wherein the second processor is configured to:
in response to reception of the file from the first user, control, in the control process, whether to issue the license information to the first user based on a determination whether the token information included in the file has been issued to the first user indicated by the identification information included in the file.

5. The information processing system according to claim 3,
wherein the storage device further stores, for each user, authentication-type information indicating an authentication type describing which apparatus, the second information processing apparatus or the user-authentication apparatus corresponding to the user, is to authenticate the user, and
wherein the second processor is configured to:
when the authentication-type information indicates that the first user corresponds to a type of user authentication performed by the second information processing apparatus, receive input of authentication information from the first user so as to perform user authentication, and control whether to issue the license information to the first user in accordance with whether the user authentication has succeeded.

6. The information processing system according to claim 4,
wherein the storage device further stores, for each user, authentication-type information indicating an authentication type describing which apparatus, the second information processing apparatus or the user-authentication apparatus corresponding to the user, is to authenticate the user, and
wherein the second processor is configured to:
when the authentication-type information indicates that the first user corresponds to a type of user authentication performed by the second information processing apparatus, receive input of authentication information from the first user so as to perform user authentication, and control whether to issue the license information to the first user in accordance with whether the user authentication has succeeded.

7. An information processing apparatus comprising:
means for storing, for each user, information about a user-authentication apparatus corresponding to the user;
means for, in response to a first user asking for token information for product activation, requesting a first user-authentication apparatus to authenticate the first user, the first user-authentication apparatus being identified to correspond to the first user by the information stored in the means for storing information;
means for, in response to reception of information indicating successful authentication of the first user from the first user-authentication apparatus as a response to the request, issuing the token information to the first user; and
means for, in response to reception of token information input from the first user, controlling whether to issue license information to the first user based on a determination whether the token information input from the first user matches the token information that has been issued to the first user.
